(19) United States
(12) Patent Application Publication
(10) Pub. No.: US 2018/0362083 A1
(43) Pub. Date: Dec. 20, 2018

(54) DRIVING STATE WARNING METHOD AND SYSTEM THEREOF

(71) Applicant: Winwise Tech Co.,Ltd., Changhua County (TW)

(72) Inventors: Yi-Feng SU, Changhua County (TW); Chan-Wei HSU, Changhua County (TW); Hsueh-Lung LIAO, Changhua County (TW)

(21) Appl. No.: 15/623,397

(22) Filed: Jun. 15, 2017

(51) Int. Cl. B62D 15/02; B60W 40/08; G07C 5/08; G06K 9/00

(52) U.S. Cl. CPC B62D 15/029; B60W 40/08; G06K 9/00798; G06K 9/00845; G07C 5/0841

(57) ABSTRACT

A driving state warning method is used for judging a driving state by a vehicle path of a vehicle. An image recognizing step is for providing an image capturing device to capture an image and recognize a lane marking of a vehicle lane according to the image. A vehicle speed judging step is for providing a vehicle speed capturing device to judge an actual vehicle speed. A crossing lane judging step is for providing a processing unit to judge whether or not the vehicle is crossing the lane marking according to the image. A consciousness judging step is for calculating a displacement of the vehicle according to the image by the processing unit and comparing whether or not the displacement is greater than a threshold value for judging consciousness of the driver. Therefore, the present disclosure can easily perform installations without any directional light detecting device.

### BACKGROUND

### Technical Field

The present disclosure relates to a driving state warning method and a driving state warning system thereof. More particularly, the driving state warning method and a driving state warning system thereof can detect a lane change intention of a driver without any directional light detecting device.

### Description of Related Art

With the progress of science and technology, the vehicles have increased significantly in popularity. However, more frequent traffic accidents occur with the frequent use of vehicles due to poor mental state of the driver, such as fatigue driving or drunken driving, etc. When the mental state of the driver is poor, the driver can not turn the steering wheel immediately, and even a vehicle deviation may occur due to the loose steering wheel.

There is a conventional lane deviation warning system which can detect whether the vehicle is located on a center of the vehicle lane or not. If the vehicle is deviating from the vehicle lane, the lane deviation warning system applies a warning to the driver. However, when the vehicle deviation is caused by driver's lack of concentration or fatigue driving, there is an over-reliance of the driver on the lane deviation warning system, and regular fatigue or regular lack of concentration will occur frequently, thereby increasing in the level of danger.

In addition, there is a conventional driving state warning system which judges the lane change intention of the driver with a directional light detecting device. If the driver has no lane change intention and the frequency of the vehicle deviation exceeds a predetermined frequency, the driving state warning system will apply the warning to the driver. However, this conventional warning system is needed to be connected with the directional light detecting device, thus significantly increasing complexity of the installation. Therefore, a driving state warning method and a driving state warning system thereof having the features of no additional directional light detecting device, convenient installation and effectively detecting the lane change intention of the driver are commercially desirable.

### SUMMARY

According to one aspect of the present disclosure, a driving state warning method for judging a driving state by a vehicle path of a vehicle includes a data storage step, an image recognizing step, a vehicle speed judging step, a crossing lane judging step and a consciousness judging step. The data storage step is for providing a database to store a vehicle deviation state model, a threshold value and a predetermined vehicle speed. The image recognizing step is for providing an image capturing device to capture an image and recognize a lane marking of a vehicle lane according to the image. The vehicle speed judging step is for providing a vehicle speed capturing device to judge whether or not an actual vehicle speed is greater than the predetermined vehicle speed. If the actual vehicle speed is smaller than or equal to a predetermined vehicle speed, a system failure step is executed, and then the image recognizing step is re-executed. The crossing lane judging step is for providing a processing unit to judge whether or not the vehicle is crossing the lane marking according to the image. If the vehicle is not crossing the lane marking, the image recognizing step is re-executed. The consciousness judging step is for calculating a displacement of the vehicle according to the image by the processing unit and comparing whether or not the displacement is greater than the threshold value for judging consciousness of the driver. If the displacement is smaller than or equal to the threshold value, the image recognizing step is re-executed.

According to another aspect of the present disclosure, a driving state warning system using the driving state warning method includes the image capturing device, the vehicle speed capturing device, the database and the processing unit. The image capturing device is configured to capture the image. The vehicle speed capturing device is configured to judge whether or not the actual vehicle speed of the vehicle is greater than the predetermined vehicle speed. The database is configured to store the vehicle deviation state model and the threshold value. The processing unit is signally connected to the image capturing device, the vehicle speed capturing device and the database. The processing unit includes a lane detecting module, a crossing lane detecting module and a changing lane detecting module. The lane detecting module receives the image and recognizes the lane marking of the vehicle lane according to the image. The crossing lane detecting module is signally connected to the lane detecting module. The crossing lane detecting module receives the image and judges whether or not the vehicle is crossing the lane marking according to the image. The changing lane detecting module is signally connected to the lane detecting module. The changing lane detecting module receives the image and calculates the displacement of the vehicle according to the image, and the changing lane detecting module compares whether or not the displacement is greater than the threshold value for judging consciousness of the driver.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a vehicle deviated from a vehicle lane;

FIG. 2 shows a flow chart of a driving state warning method according to one embodiment of the present disclosure;

FIG. 3 shows a block diagram of a driving state warning system using the driving state warning method of FIG. 2;

FIG. 4A shows a schematic view of a vector diagram of the vehicle of FIG. 1;

FIG. 4B shows a schematic view of a displacement of the vehicle and positional relationships between the vehicle and the vehicle lane;

FIG. 5 shows a graph of a lane deviation warning signal, a lane changing signal and a driving status signal of the driving state warning system of FIG. 3 when the driver unconsciously changes the vehicle lane;

FIG. 6 shows a graph of the lane deviation warning signal, the lane changing signal and the driving status signal of the driving state warning system of FIG. 3 when the driver consciously changes the vehicle lane;

FIG. 7 shows a flow chart of a driving state warning method according to another embodiment of the present disclosure; and

FIG. 8 shows a block diagram of a driving state warning system using the driving state warning method of FIG. 7.

### DETAILED DESCRIPTION

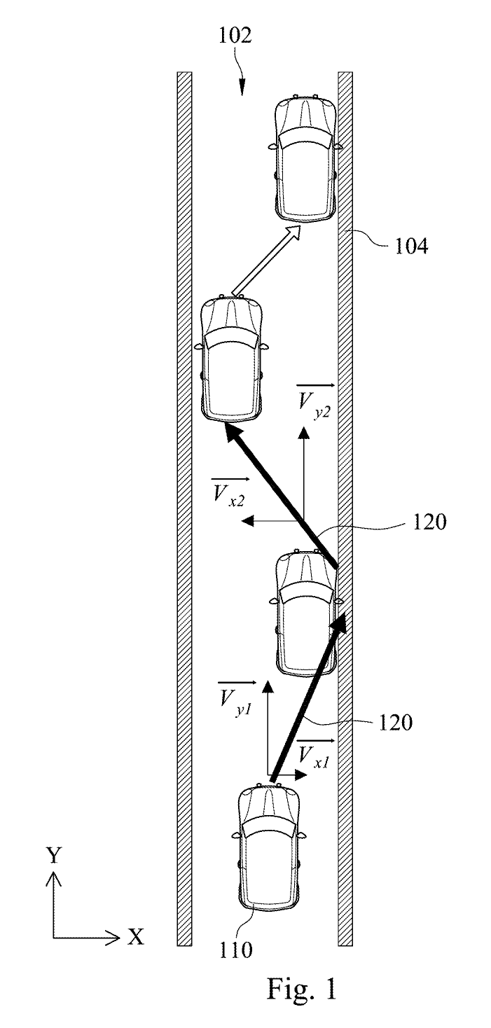

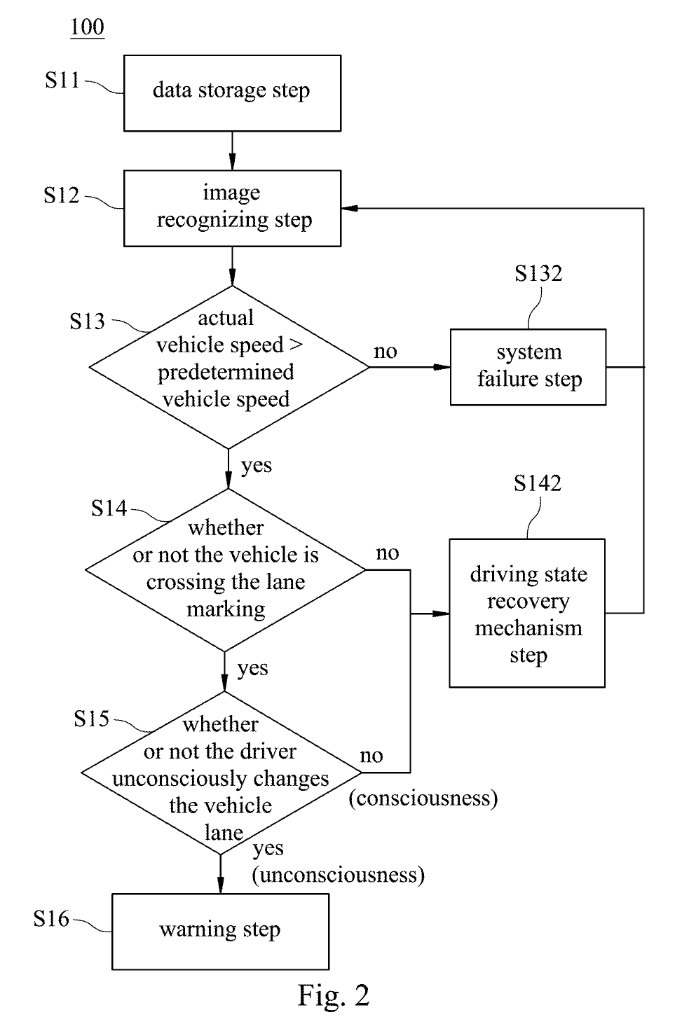

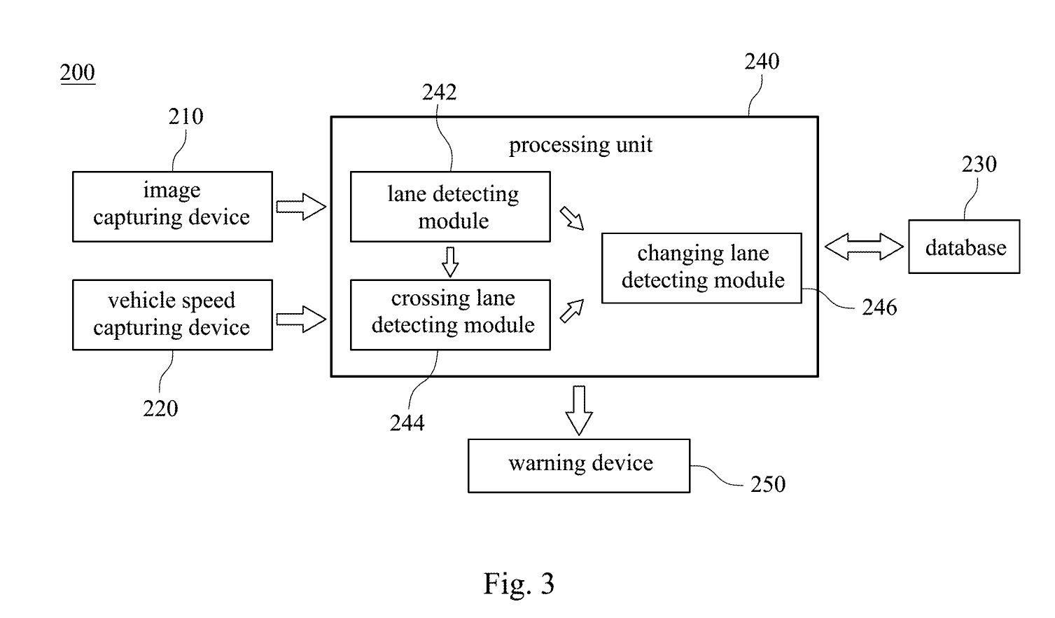

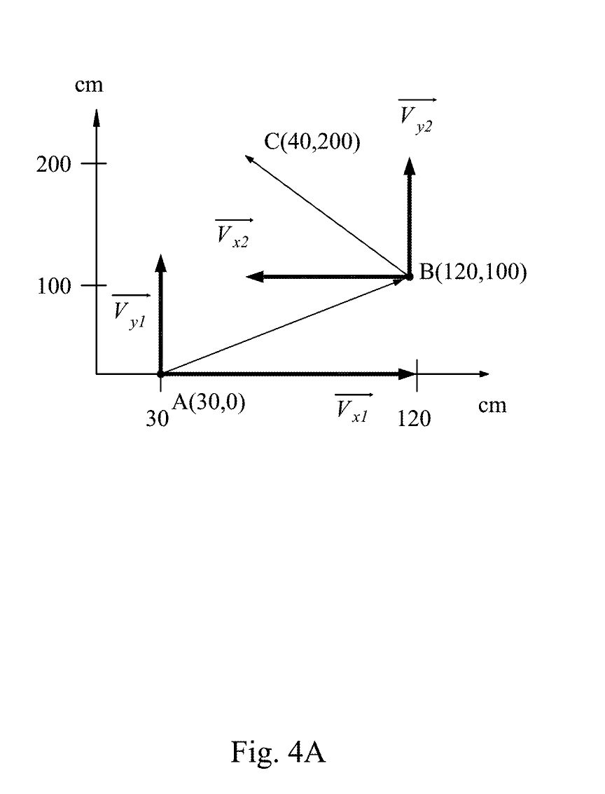

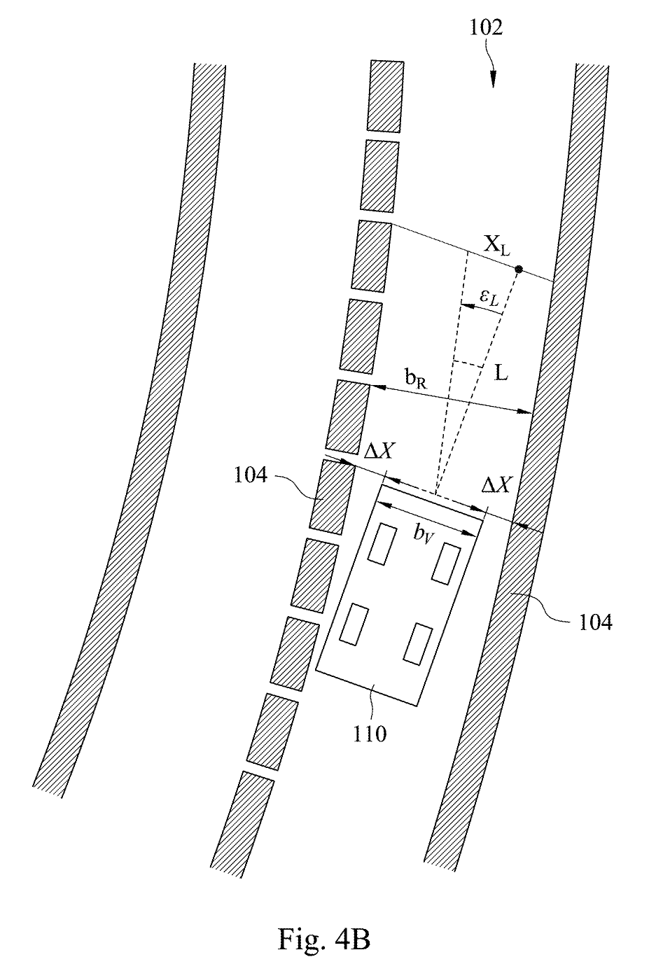

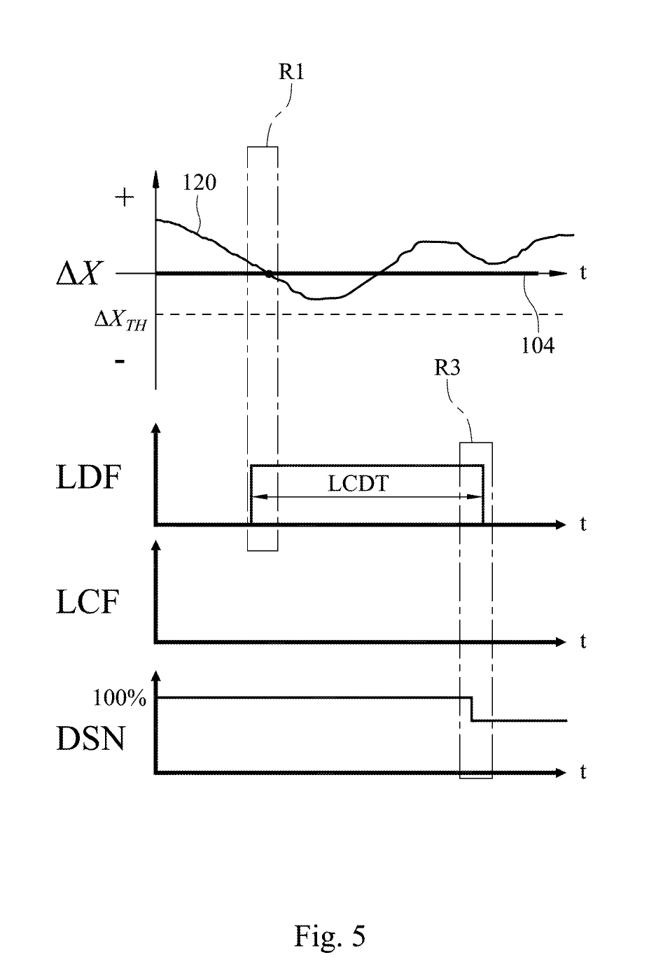

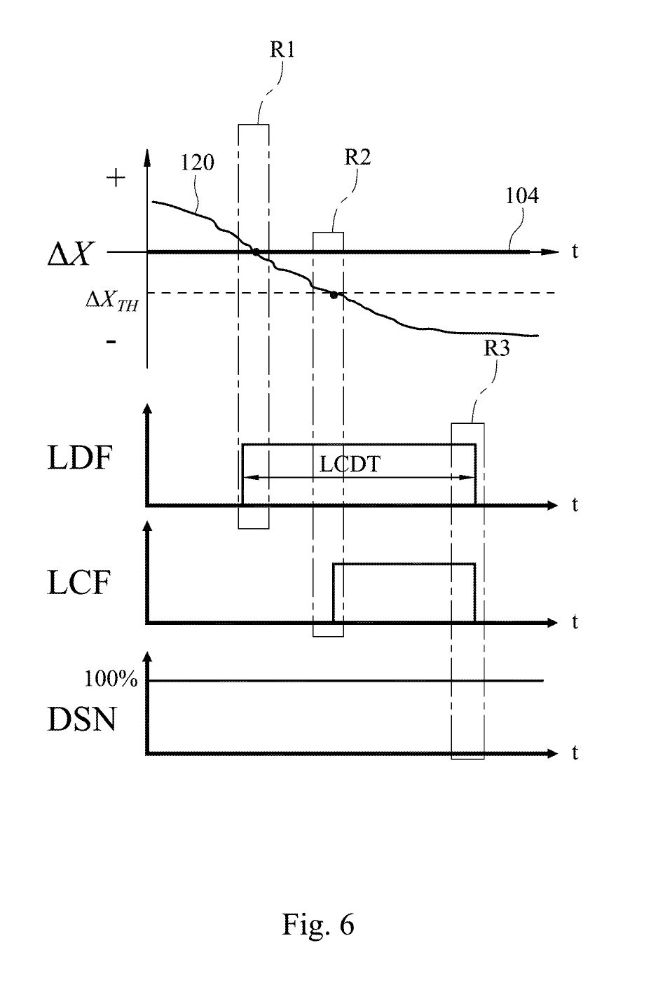

FIG. 1 shows a schematic view of a vehicle 110 deviated from a vehicle lane 102; FIG. 2 shows a flow chart of a driving state warning method 100 according to one embodiment of the present disclosure; FIG. 3 shows a block diagram of a driving state warning system 200 using the driving state warning method 100 of FIG. 2; FIG. 4A shows a schematic view of a vector diagram of the vehicle 110 of FIG. 1; FIG. 4B shows a schematic view of a displacement ΔX of the vehicle 110 and positional relationships between the vehicle 110 and the vehicle lane 102; FIG. 5 shows a graph of a lane deviation warning signal LDF, a lane changing signal LCF and a driving status signal DSN of the driving state warning system 200 of FIG. 3 when the driver unconsciously changes the vehicle lane 102; and FIG. 6 shows a graph of the lane deviation warning signal LDF, the lane changing signal LCF and the driving status signal DSN of the driving state warning system 200 of FIG. 3 when the driver consciously changes the vehicle lane 102. In FIG. 2, the driving state warning method 100 is performed by the driving state warning system 200. The driving state warning method 100 for judging a driving state by a vehicle path 120 of the vehicle 110 includes a data storage step S11, an image recognizing step S12, a vehicle speed judging step S13, a system failure step S132, a crossing lane judging step S14, a driving state recovery mechanism step S142, a consciousness judging step S15 and a warning step S16.

The data storage step S11 is for providing a database 230 to store a vehicle deviation state model, a threshold value ΔX_{TH} and a predetermined vehicle speed. In detail, the vehicle deviation state model includes a first vehicle lane center deviation x1, a second vehicle lane center deviation x2, a first moving time t1 and a second moving time t2. The first vehicle lane center deviation x1 represents a distance between a first position A to a second position B in an X-axis direction. The vehicle 110 is deviated from a center of the vehicle lane 102 and is moved from the first position A to the second position B, as shown in FIG. 4A. The second vehicle lane center deviation x2 represents a distance between the second position B to a third position C in the X-axis direction. The vehicle 110 is moved to a center of the vehicle lane 102 and is moved from the second position B to the third position C. The first moving time t1 represents a time interval in which the vehicle 110 is moved from the first position A to the second position B. The second moving time t2 represents a time interval in which the vehicle 110 is moved from the second position B to the third position C. A first deviating vehicle speed \vec{Vₓ₁} is calculated from the first vehicle lane center deviation x1 and the first moving time t1. A second deviating vehicle speed \vec{Vₓ₂} is calculated from the second vehicle lane center deviation x2 and the second moving time t2. The first deviating vehicle speed \vec{Vₓ₁} is equal to the first vehicle lane center deviation x1 divided by the first moving time t1, i.e., \vec{Vₓ₂}=dx1/dt1. The second deviating vehicle speed \vec{Vₓ₂} is equal to the second vehicle lane center deviation x2 divided by the second moving time t2, i.e., \vec{Vₓ₂}=dx2/dt2. In addition, the predetermined vehicle speed is equal to or greater than 60 km/hr, and the threshold value ΔX_{TH} is greater than or equal to 30 cm, and is smaller than or equal to 150 cm. In FIGS. 1 and 4A, the predetermined vehicle speed is equal to 60 km/hr, and the threshold value ΔX_{TH} is equal to 50 cm. Certainly, these settings can be adjusted by a user according to the actual needs of the practical applications.

The image recognizing step S12 is for providing an image capturing device 210 to capture an image and recognize a lane marking 104 of the vehicle lane 102 according to the image. In detail, the image capturing device 210 transmits the image to a lane detecting module 242 of a processing unit 240, and then the lane detecting module 242 recognizes the lane marking 104 of the current vehicle lane 102 of the vehicle 110 according to the image via an image recognition algorithm. The image capturing device 210 outputs a plurality of positional coordinates of the lane marking 104 to the database 230, and the positional coordinates of the lane marking 104 are stored in the database for use in a next step.

The vehicle speed judging step S13 is for providing a vehicle speed capturing device 220 to judge whether or not an actual vehicle speed of the vehicle 110 is greater than the predetermined vehicle speed. If the actual vehicle speed is smaller than or equal to the predetermined vehicle speed, a system failure step S132 is executed, and then the image recognizing step S12 is re-executed. In contrast to the predetermined vehicle speed, if the actual vehicle speed is greater than the predetermined vehicle speed, the crossing lane judging step S14 is performed.

The crossing lane judging step S14 is for providing a crossing lane detecting module 244 of the processing unit 240 to judge whether or not the vehicle 110 is crossing the lane marking 104 according to the image. If the vehicle 110 is not crossing the lane marking 104, the driving state recovery mechanism step S142 is performed to enter a driving state recovery mechanism, and the image recognizing step S12 is re-executed. The driving state recovery mechanism represents that the driving status signal DSN is equal to 100%. On the contrary, if the vehicle 110 is crossing the lane marking 104, the consciousness judging step S15 is performed. In detail, in the crossing lane judging step S14, when the vehicle 110 is not crossing the lane marking 104, the lane deviation warning signal LDF is clear to 0 by the processing unit 240. When the vehicle 110 is crossing the lane marking 104, the lane deviation warning signal LDF is set to 1 by the processing unit 240. The deviation change of the lane deviation warning signal LDF is corresponding to the displacement ΔX of the vehicle 110 being 0 at a first trigger point R1, as shown in FIGS. 5 and 6. The lane deviation warning signal LDF is stored in the database 230 and is considered as “lane displacement flag” which represents that whether the vehicle 110 is crossing the lane marking 104. In FIGS. 5 and 6, the displacement ΔX represents a distance between the vehicle 110 and the lane marking 104. A lane change detecting time LCDT represents the duration of the lane deviation warning signal LDF being 1, and the length of the lane change detecting time LCDT can be determined by the user.

The consciousness judging step S15 is for calculating the displacement ΔX of the vehicle 110 according to the image by a changing lane detecting module 246 of the processing unit 240 and comparing whether or not the displacement ΔX is greater than the threshold value ΔX_{TH} for judging consciousness of the driver. If the displacement ΔX is smaller than or equal to the threshold value ΔX_{TH}, the driving state recovery mechanism step S142 is performed to enter the driving state recovery mechanism, and the image recognizing step S12 is re-executed. In contrast, if the displacement ΔX is greater than the threshold value ΔX_{TH}, the warning step S16 is performed. In detail, in the consciousness judging step S15, when the vehicle 110 has crossed the lane marking 104 and the distance between the vehicle 110 and the lane marking 104 is smaller than the threshold value ΔX_{TH}, the lane changing signal LCF is clear to 0 by the processing unit 240. Conversely, when the vehicle 110 has crossed the lane marking 104 and the distance between the vehicle 110 and the lane marking 104 is greater than or equal to the threshold value ΔX_{TH}, the lane changing signal LCF is set to 1 by the processing unit 240. The change of the lane changing signal LCF is corresponding to the displacement ΔX of the vehicle 110 being equal to the threshold value ΔX_{TH} at a second trigger point R2, as shown in FIG. 6. The lane changing signal LCF is stored in the database 230 and is considered as “lane changing flag” which represents that whether the vehicle 110 has changed the vehicle lane 102. Moreover, the user can employ the processing unit 240 to set the driving status signal DSN to 100%. The driving status signal DSN is corresponding to the mental state of the driver. When the lane deviation warning signal LDF is 1 and the lane changing signal LCF is 0, the processing unit 240 judges that the driver unconsciously changes the vehicle lane 102, and the processing unit 240 subtracts a predetermined deduction value from the driving status signal DSN at a third trigger point R3, as shown in FIG. 5. When the driver unconsciously does lane change, it means that the driver does not concentrate on the driving or carelessly controls the vehicle 110 to cross the lane marking 104. The driver suddenly hears a warning sound or feels the vibration from the vehicle 110 being travelling on cat's eyes or lane markers on the lane marking 104, and then the driver controls the vehicle 110 to return to the original vehicle lane 102. When the lane deviation warning signal LDF is 1 and the lane changing signal LCF is 1, the processing unit 240 maintains the driving status signal DSN and judges that the driver consciously changes the vehicle lane 102 at the third trigger point R3, as shown in FIG. 6. When the driver consciously changes the vehicle lane 102, it means that the driver has a lane change intention, and the driver stably controls the vehicle 110 to change lanes from the current vehicle lane 102 to the adjacent vehicle lane 102. The procedure usually accompanies a switching operation of a directional light.

The warning step S16 is for applying a warning device 250 to show the lane deviation warning signal LDF, the lane changing signal LCF or the driving status signal DSN by using an auditory display or a visual display. Therefore, the driving state warning method 100 of the present disclosure uses the deviation condition of the vehicle 110 to estimate the driving state and consciousness of the driver, and provides quantitative data, graphics or warning sounds correlating to the vehicle lane 102 to the driver, so that the driver can immediately know whether or not his/her own mental state is suitable for driving the vehicle 110. In addition, the driving state warning method 100 of the present disclosure can detect the lane change intention of the driver without any directional light detecting device so as to easily install the driving state warning system 200 on the vehicle 110. Accordingly, the driving state warning method 100 of the present disclosure solves the problems of the conventional technique which requires the directional light detecting device to detect the lane change intention of the driver.

FIG. 3 shows the block diagram of the driving state warning system 200 using the driving state warning method 100 of FIG. 2. The driving state warning system 200 is disposed in a traffic recorder to identify the conditions of the front of the vehicle 110 and the adjacent vehicle lane 102. The driving state warning system 200 includes an image capturing device 210, a vehicle speed capturing device 220, a database 230, a processing unit 240 and a warning device 250. The image capturing device 210 is configured to capture the image. The image capturing device 210 is faced toward the front of the vehicle 110, i.e., the image capturing device 210 is faced toward a Y-axis direction. The image capturing device 210 may be a camera. The vehicle speed capturing device 220 is configured to judge whether or not the actual vehicle speed of the vehicle 110 is greater than the predetermined vehicle speed. The vehicle speed capturing device 220 may be a global positioning system (GPS) or a vehicle speedometer for capturing the actual vehicle speed. The database 230 is configured to store the vehicle deviation state model and the threshold value ΔX_{TH}. The database 230 can be connected to a cloud server. Furthermore, the processing unit 240 is signally connected to the image capturing device 210, the vehicle speed capturing device 220, the database 230 and the warning device 250. The processing unit 240 includes a lane detecting module 242, a crossing lane detecting module 244 and a changing lane detecting module 246. The lane detecting module 242 receives the image from the image capturing device 210 and recognizes the lane marking 104 of the vehicle lane 102 which the vehicle 110 is travelling on according to the image. The crossing lane detecting module 244 is signally connected to the lane detecting module 242. The crossing lane detecting module 244 receives the image and judges whether or not the vehicle 110 is crossing the lane marking 104 according to the image. The changing lane detecting module 246 is signally connected to the lane detecting module 242 and the crossing lane detecting module 244. The changing lane detecting module 246 receives the image and calculates the displacement ΔX of the vehicle 110 according to the image. The changing lane detecting module 246 compares whether or not the displacement ΔX is greater than the threshold value ΔX_{TH} for judging consciousness of the driver. The displacement ΔX of the vehicle 110 is corresponding to a distance between the lane marking 104 and a side of the vehicle 110 which has crossed over the lane marking 104. Moreover, before the changing lane detecting module 246 calculating the displacement ΔX and comparing the displacement ΔX to the threshold value ΔX_{TH}, the crossing lane detecting module 244 needs first to detect the vehicle 110 which has crossed over the lane marking 104. If the vehicle 110 is not crossing the lane marking 104, the changing lane detecting module 246 is operated in a standby mode. In addition, the warning device 250 is signally connected to the processing unit 240. The warning device 250 is configured to show the lane deviation warning signal LDF, the lane changing signal LCF and the driving status signal DSN by using the auditory display or the visual display. The warning device 250 can be a speaker, an LED, or a screen for showing various warnings in different manners. Hence, the driving state warning system 200 of the present disclosure can detect the lane change intention of the driver without any directional light detecting device, thereby easily installing the driving state warning system 200 on the vehicle 110. At the same time, the driving state warning system 200 of the present disclosure solves the problems of the conventional technique which requires the directional light detecting device to detect the lane change intention of the driver.

In FIGS. 3 and 4B, a lane marking model is obtained by a quadratic curve fitting equation. The driving state warning system 200 of the present disclosure utilizes the quadratic curve fitting equation to estimate the behavior of the vehicle 110 changing the vehicle lane 102. The quadratic curve fitting equation can be described as follows:

x=k·y²+m·y+b (1),

wherein the parameters x, y are horizontal and vertical axes of an actual plane of the lane marking model, respectively. The parameters k, m, b are obtained by the conventional lane marking model. A lane marking slope ε_{L} can be calculated by the lane marking model, and the lane marking slope ε_{L} can be described as follows:

ε_{L}=2·k·y+m (2).

In addition, a lateral displacement Δ of the vehicle 110 can be calculated by the lane marking slope ε_{L}, and the lateral displacement Δ is equal to “X_{L}−L×ε_{L}”, wherein X_{L} represents a displacement of the vehicle 110 at a reference point. L and εₜ represent a preview distance of the vehicle 110 and the slope of the vehicle lane 102, respectively. The quadratic curve fitting equation is used to calculate the vehicle path 120 and the displacement ΔX between the vehicle 110 and the lane marking 104. The displacement ΔX can be described as follows:

$$Δ X = \{ \frac{\frac{{b}_{R}}{2} - ( \frac{{b}_{V}}{2} + {X}_{L} )}{\frac{{b}_{R}}{2} - ( \frac{{b}_{V}}{2} - {X}_{L} )} , \qquad ( 3 )$$

wherein b_{R} represents a width of the vehicle lane 102, and b_{V} represents a width of the vehicle 110. Therefore, the processing unit 240 of the present disclosure can obtain the lane marking slope ε_{L}, the lateral displacement Δ and the displacement ΔX by the above-mentioned equations (1), (2) and (3) so as to generate the lane deviation warning signal LDF, the lane changing signal LCF and the driving status signal DSN for judging whether the driver consciously changes the vehicle lane 102 or not.

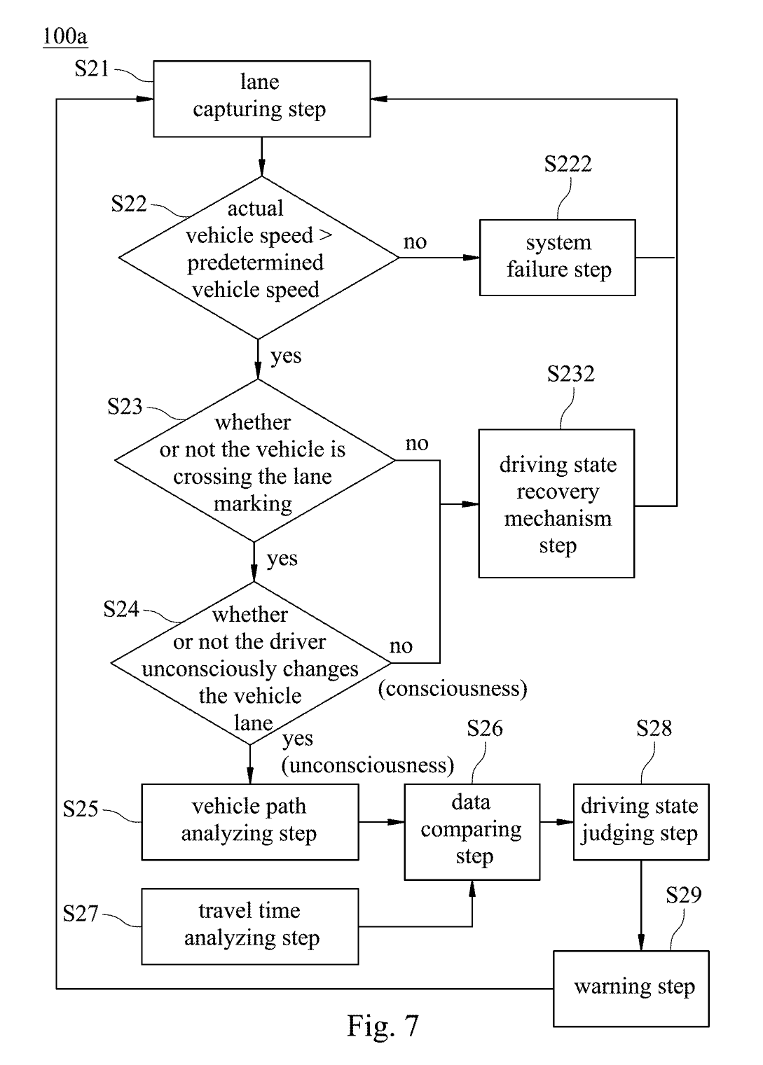

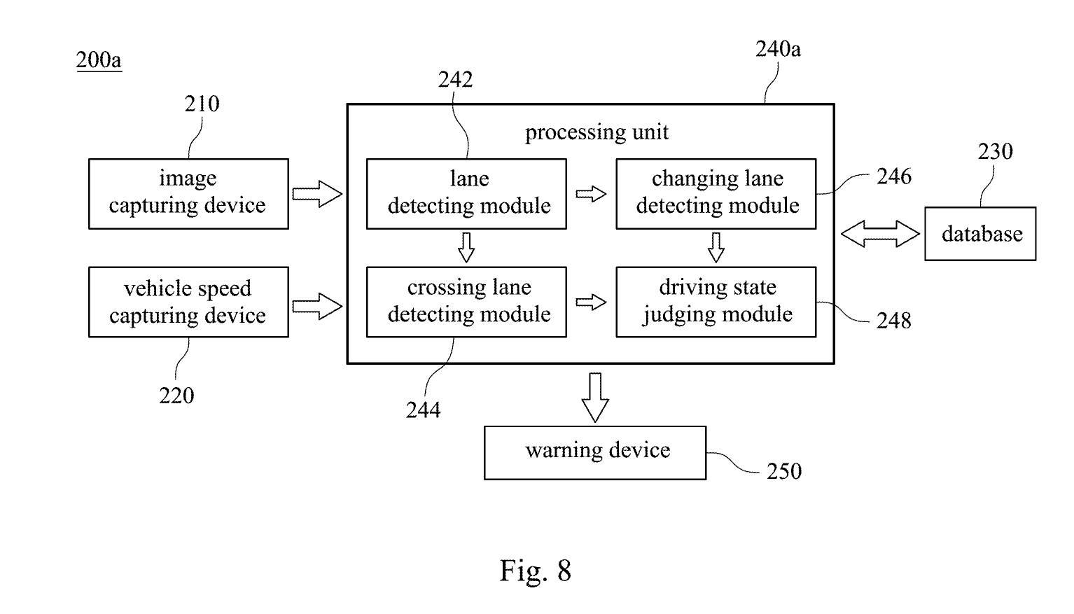

FIG. 7 shows a flow chart of a driving state warning method 100a according to another embodiment of the present disclosure; and FIG. 8 shows a block diagram of a driving state warning system 200a using the driving state warning method 100a of FIG. 7. In FIG. 7, the driving state warning method 100a includes a lane capturing step S21, a vehicle speed judging step S22, a system failure step S222, a crossing lane judging step S23, a driving state recovery mechanism step S232, a consciousness judging step S24, a vehicle path analyzing step S25, a data comparing step S26, a travel time analyzing step S27, a driving state judging step S28 and a warning step S29.

In FIG. 7, the detail of the vehicle speed judging step S22, the system failure step S222, the crossing lane judging step S23, the driving state recovery mechanism step S232, the consciousness judging step S24 and the warning step S29 is the same as the embodiments of FIG. 2, and will not be described again herein. In FIG. 7, the driving state warning method 100a further includes the lane capturing step S21, the vehicle path analyzing step S25, the data comparing step S26, the travel time analyzing step S27 and the driving state judging step S28. The lane capturing step S21 includes the data storage step S11 and the image recognizing step S12. The lane capturing step S21 is for capturing the lane marking 104 of the vehicle lane 102 which the vehicle 110 is travelling on according to the image. After the consciousness judging step S24 judging that the driver unconsciously changes the vehicle lane 102 (i.e., unconsciousness in FIG. 7), the vehicle path analyzing step S25 is performed. The vehicle path analyzing step S25 is for analyzing the vehicle path 120 of the vehicle 110 by a processing unit 240a. Then, the driving state warning method 100a performs the data comparing step S26 for comparing the deviating vehicle speeds and the vehicle deviation state model by a driving state judging module 248 of the processing unit 240a. The travel time analyzing step S27 is for analyzing a travel time interval and applying the travel time interval to the data comparing step S26 for the basic of the comparison. After that, the driving state judging step S28 is for calculating the first deviating vehicle speed \vec{Vₓ₁} and the second deviating vehicle speed \vec{Vₓ₂} of the vehicle 110 according to the image and travel time interval by driving state judging module 248 of the processing unit 240a when the vehicle 110 is deviated from the vehicle lane 102. The driving state judging step S28 is for comparing the first deviating vehicle speed \vec{Vₓ₁}, the second deviating vehicle speed \vec{Vₓ₂} and the vehicle deviation state model to evaluate the driving state of the driver. There are four predetermined conditions in the vehicle deviation state model. When the driving state evaluated by the driving state judging step S28 is corresponding to one of the four predetermined conditions of the vehicle deviation state model, the driving status signal DSN subtracts a certain percentage. The higher the value of the driving status signal DSN, the better the driving state of the driver. In detail, when the first deviating vehicle speed \vec{Vₓ₁} and the second deviating vehicle speed \vec{Vₓ₂} are smaller than 50 cm/s as well as the vehicle 110 deviated from the vehicle lane 102, the mental state of the driver is defined as “careless driving”. When the first deviating vehicle speed \vec{Vₓ₁} is smaller than 50 cm/s and the second deviating vehicle speed \vec{Vₓ₂} is greater than or equal to 50 cm/s as well as the vehicle 110 deviated from the vehicle lane 102, the mental state of the driver is defined as “lack of concentration”. When the first deviating vehicle speed \vec{Vₓ₁} is greater than or equal to 50 cm/s and the second deviating vehicle speed \vec{Vₓ₂} is smaller than 50 cm/s as well as the vehicle 110 deviated from the vehicle lane 102, the mental state of the driver is defined as “fatigue driving or lack of concentration”. When the vehicle 110 is deviated from the vehicle lane 102, and the first deviating vehicle speed \vec{Vₓ₁} and the second deviating vehicle speed \vec{Vₓ₂} are both greater than or equal to 50 cm/s as well as the vehicle 110 deviated from the vehicle lane 102, the mental state of the driver is defined as “fatigue driving”.

Furthermore, the driving state warning method 100a of the present disclosure provides different percentages subtracted from the driving status signal DSN according to the corresponding mental state of the driver. For example, “careless driving” represents that the driving status signal DSN subtracts 10%. “Lack of concentration” represents that the driving status signal DSN subtracts 20%. “Fatigue driving or lack of concentration” represents that the driving status signal DSN subtracts 30%. “Fatigue driving” represents that the driving status signal DSN subtracts 40%. Other conditions represent that the driving status signal DSN subtracts 10%. In FIG. 4A, the first deviating vehicle speed \vec{Vₓ₁} is equal to 90 cm/s and the second deviating vehicle speed \vec{Vₓ₂} is equal to 80 cm/s, so that the mental state of the driver belongs to “fatigue driving”, and the corresponding driving status signal DSN is 60% if an initial value of the driving status signal DSN is 100%. When the vehicle 110 is deviated from the vehicle lane 102 and the lane deviation warning signal LDF and the lane changing signal LCF are both 1, the processing unit 240 maintains the driving status signal DSN and judges that the driver consciously changes the vehicle lane 102. In addition, the driving state recovery mechanism step S142, S232 represents that when the vehicle 110 is returned to the center of the vehicle lane 102 and stably travelling on the vehicle lane 102 without any abnormality during a suitable interval, the driving status signal DSN adds a certain percentage until the driving status signal DSN is equal to 100%. For example, if the suitable interval is 150 seconds, i.e., “careless driving”, “lack of concentration” and “fatigue driving” do not occur during 150 seconds, the driving status signal DSN adds 10% and is shown by the warning device 250. The driver can obtain quantitative data, graphics or warning sounds provided by the warning device 250. The warning step S29 is for applying the warning device 250 to show the mental state of the driver by using the auditory display or the visual display, so that the driver can immediately obtain the driving status signal DSN evaluated from the driving state judging module 248. Owing to automatic auditory and/or visual reminders, the driver can park for taking a rest or raise an alert lest a traffic accident occur. Therefore, the present disclosure provides quantitative data, graphics or warning sounds correlating to the mental state of the driver, so that the driver can know whether or not his/her own mental state is suitable for driving the vehicle 110.

In FIG. 8, the driving state warning system 200a includes an image capturing device 210, a vehicle speed capturing device 220, a database 230, a processing unit 240a and a warning device 250. The detail of the image capturing device 210, the vehicle speed capturing device 220, the database 230, the lane detecting module 242, the crossing lane detecting module 244, the changing lane detecting module 246 and warning device 250 is the same as the embodiments of FIG. 3, and will not be described again herein. In FIG. 8, the processing unit 240a of the driving state warning system 200a further includes a driving state judging module 248 which is signally connected to the crossing lane detecting module 244 and the changing lane detecting module 246. The driving state judging module 248 is configured to calculate plural deviating vehicle speeds of the vehicle 110 according to the image when the vehicle 110 is deviated from the vehicle lane 102 and compare the deviating vehicle speed and the vehicle deviation state model to evaluate the driving state (i.e., the mental state of the driver). The mental state of the driver is corresponding to the driving status signal DSN. Accordingly, the driving state warning system 200a of the present disclosure can immediately and accurately detect the lane change intention and the mental state of the driver without any directional light detecting device so as to easily install the driving state warning system 200a on the vehicle 110 and apply corresponding warnings.

According to the aforementioned embodiments and examples, the advantages of the present disclosure are described as follows.

1. The driving state warning method and the driving state warning system thereof of the present disclosure can detect the lane change intention and the mental state of the driver according to the image without any directional light detecting device so as to easily install the system on the vehicle and apply corresponding warnings to the driver.

2. The driving state warning method and the driving state warning system thereof of the present disclosure can detect the lane change intention of the driver without any directional light detecting device so as to easily install the driving state warning system on the vehicle and reduce installation costs, time and interconnecting cables. Therefore, the driving state warning method and system thereof of the present disclosure solves the problems of the conventional technique which requires the directional light detecting device to detect the lane change intention of the driver.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A driving state warning method for judging a driving state by a vehicle path of a vehicle, the driving state warning method comprising:
providing a data storage step, wherein the data storage step is for providing a database to store a vehicle deviation state model, a threshold value and a predetermined vehicle speed;
providing an image recognizing step, wherein the image recognizing step is for providing an image capturing device to capture an image and recognize a lane marking of a vehicle lane according to the image;
providing a vehicle speed judging step, wherein the vehicle speed judging step is for providing a vehicle speed capturing device to judge whether or not an actual vehicle speed is greater than the predetermined vehicle speed, and if the actual vehicle speed is smaller than or equal to the predetermined vehicle speed, a system failure step is executed, and then the image recognizing step is re-executed;
providing a crossing lane judging step, wherein the crossing lane judging step is for providing a processing unit to judge whether or not the vehicle is crossing the lane marking according to the image, and if the vehicle is not crossing the lane marking, the image recognizing step is re-executed; and
providing a consciousness judging step, wherein the consciousness judging step is for calculating a displacement between the vehicle and the lane marking according to the image by the processing unit and comparing whether or not the displacement is greater than the threshold value for judging consciousness of the driver, and if the displacement is smaller than or equal to the threshold value, the image recognizing step is re-executed.

2. The driving state warning method of claim 1, further comprising:
providing a driving state judging step, wherein the driving state judging step is for calculating at least one deviating vehicle speed of the vehicle according to the image by the processing unit when the vehicle is deviated from the vehicle lane and comparing the deviating vehicle speed and the vehicle deviation state model to evaluate the driving state.

3. The driving state warning method of claim 2, wherein,
the vehicle lane is extended toward a Y-axis direction, and the vehicle deviation state model comprises:
a first vehicle lane center deviation representing a distance between a first position to a second position in an X-axis direction, wherein the vehicle is deviated from a center of the vehicle lane and is moved from the first position to the second position;
a second vehicle lane center deviation representing a distance between the second position to a third position in the X-axis direction, wherein the vehicle is moved to a center of the vehicle lane and is moved from the second position to the third position;
a first moving time representing a time interval in which the vehicle is moved from the first position to the second position; and
a second moving time representing a time interval in which the vehicle is moved from the second position to the third position;
wherein the deviating vehicle speed is calculated from the first vehicle lane center deviation, the second vehicle lane center deviation, the first moving time and the second moving time.

4. The driving state warning method of claim 1, wherein,
in the crossing lane judging step, when the vehicle is not crossing the lane marking, a lane deviation warning signal is clear to 0 by the processing unit and stored in the database; and
when the vehicle is crossing the lane marking, the lane deviation warning signal is set to 1 by the processing unit and stored in the database.

5. The driving state warning method of claim 4, wherein,
in the consciousness judging step, when the displacement is smaller than the threshold value, a lane changing signal is clear to 0 by the processing unit and stored in the database; and
when the displacement is greater than or equal to the threshold value, the lane changing signal is set to 1 by the processing unit and stored in the database.

6. The driving state warning method of claim 5, wherein,
in the consciousness judging step, when the lane deviation warning signal is 1 and the lane changing signal is 0, the processing unit judges that the driver unconsciously changes the vehicle lane; and
when the lane deviation warning signal is 1 and the lane changing signal is 1, the processing unit judges that the driver consciously changes the vehicle lane.

7. The driving state warning method of claim 6, further comprising:
providing a warning step, wherein the warning step is for applying a warning device to show the lane deviation warning signal, the lane changing signal or a driving status signal by using an auditory display or a visual display.

8. A driving state warning system using the driving state warning method of claim 1, comprising:
the image capturing device configured to capture the image;
the vehicle speed capturing device configured to judge whether or not the actual vehicle speed of the vehicle is greater than the predetermined vehicle speed;
the database configured to store the vehicle deviation state model and the threshold value; and
the processing unit signally connected to the image capturing device, the vehicle speed capturing device and the database, and the processing unit comprising:
a lane detecting module receiving the image and recognizing the lane marking of the vehicle lane according to the image;
a crossing lane detecting module signally connected to the lane detecting module, wherein the crossing lane detecting module receives the image and judges whether or not the vehicle is crossing the lane marking according to the image; and
a changing lane detecting module signally connected to the lane detecting module, wherein the changing lane detecting module receives the image and calculates the displacement of the vehicle according to the image, and the changing lane detecting module compares whether or not the displacement is greater than the threshold value for judging consciousness of the driver.

9. The driving state warning system of claim 8, wherein the processing unit further comprises:
a driving state judging module signally connected to the crossing lane detecting module and the changing lane detecting module, wherein the driving state judging module is configured to calculate at least one deviating vehicle speed of the vehicle according to the image when the vehicle is deviating from the vehicle lane and compare the deviating vehicle speed and the vehicle deviation state model to evaluate the driving state.

10. The driving state warning system of claim 8, further comprising:
a warning device signally connected to the processing unit, wherein the warning device is configured to show a lane deviation warning signal, a lane changing signal and a driving status signal by using an auditory display or a visual display.
